(19) United States
(12) Patent Application Publication
(10) Pub. No.: US 2003/0061791 A1
(43) Pub. Date: Apr. 3, 2003

(54) Microwave system used for heating silicon carbide filter in diesel engine exhaust system

(75) Inventors: Richard L. Barbier, Montgomery, PA (US); Thomas M. Bemis, Montoursville, PA (US); Gregory T. Schaeffer, Cogan Station, PA (US); Michael S. Worthington, Unityville, PA (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Litton Systems, Inc.

(21) Appl. No.: 09/968,018

(22) Filed: Oct. 2, 2001

(51) Int. Cl. B01D 46/00

(52) U.S. Cl. 55/282.3; 55/523

(57) ABSTRACT

A silicon carbide filter includes a filter body and has a cavity formed therein. A microwave RF energy source is coupled to the cavity. A lossy media is disposed in the cavity for absorbing microwave energy. A reflective screen is spaced a predetermined distance from the input screen to define an input lossy volume and to define an output lossy volume between the reflective screen and the output screen. The input lossy volume includes a central less lossy section and an outer more lossy section, wherein in the outlet lossy volume the lossy media is less lossy than in the input lossy volume.

### TECHNICAL FIELD

The present invention relates generally to regenerative filters, and more particularly, to a regenerative filter using microwave energy which is distributed evenly across the filter to ensure even heating of the regenerative filter and also to heat and combust particulates trapped in the filter. The present invention relates to a regenerative filter usable in a diesel engine exhaust system.

### BACKGROUND ART

Silicon carbide filters, due to its absorption properties can be heated by microwave or radiation energy for regeneration of diesel particulate filters. The diesel engine waste products which are exhausted include nitrous oxide NOₓ and particulate matter PM emissions. Other diesel emissions include nitrogen oxides, hydrocarbon and carbon monoxide and some of the non-regulated emissions including sulfur dioxide and nitric oxide.

The difficulty with prior art approaches using regenerative filters is that the filter was not heated evenly and therefore the filter did not efficiently combust the exhaust particles trapped in the filter, thus not regenerating the entire filter. One such filter is disclosed, for example, in U.S. Pat. No. 5,087,272, which is hereby incorporated by reference in its entirety into the present specification.

### SUMMARY OF THE INVENTION

It is an aspect of the present invention to provide a regenerative filter which can uniformly heat the filter and cause combustion of the combustible materials trapped in the filter.

It is yet another aspect of the present invention to uniformly heat a regenerative filter using RF microwave energy.

In yet another aspect of the present invention, a reflective screen divides an inner volume of the regenerative filter to enable the microwave energy to bring the filter up to combustion temperature.

In a still further aspect of the present invention, a coaxial microwave cavity is provided to uniformly heat the filter and to heat and combust particulates trapped in the filter.

In another aspect of the present invention, a filter element is heated to 550° C. and this temperature is maintained while gas flows through the filter at a 35 CFM flow rate.

These and other aspects of the present invention are achieved by a silicon carbide filter that includes a filter body and has a cavity formed therein. A microwave RF energy source is coupled to the cavity. A lossy media is disposed in the cavity for absorbing emitted microwave energy.

The foregoing and other aspects of the present invention are achieved by a silicon carbide filter that includes a filter body and has a cavity formed therein. A microwave RF energy source is coupled to the cavity. A lossy media is disposed in the cavity for absorbing microwave energy. A reflective screen is spaced a predetermined distance from the input screen to define an input lossy volume and to define an output lossy volume between the reflective screen and the output screen. The input lossy volume includes a central less lossy section and an outer more lossy section, wherein in the outlet lossy volume the lossy media is less lossy than in the input lossy volume.

Still other aspects and advantages of the present invention will become readily apparent to those skilled in the art from the following detailed description, wherein the preferred embodiments of the invention are shown and described, simply by way of illustration of the best mode contemplated by carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

FIG. 1A is a cross-sectional side elevational view of the inventive filter according to the principles of the present invention;

FIG. 1B is a left elevational side view of the filter of FIG. 1A; and

FIG. 2 is a schematic diagram of a microwave energy source including a magnetron, waveguide and connector which connects to the filter assembly of FIGS. 1A and 1B.

### BEST MODE FOR CARRYING OUT THE INVENTION

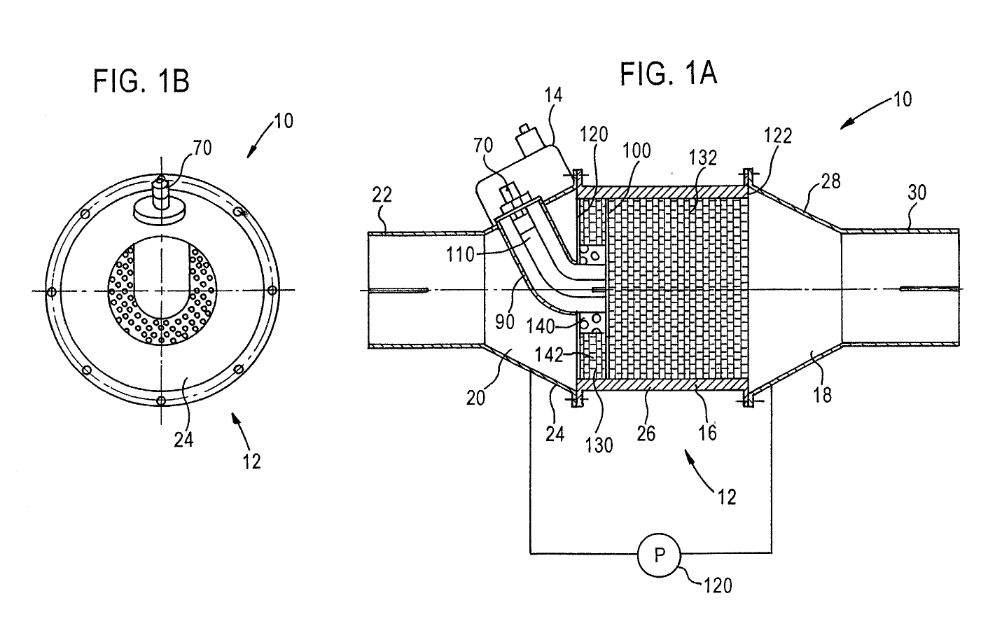

Referring first to FIG. 1A, an inventive filter assembly 10 according to the principles of the present invention is illustrated in a horizontal position. It should be understood that the inventive filter assembly 10 is usable in any orientation. Also it should be appreciated that although the present invention is especially useful for diesel engine exhaust, the present invention is equally usable for any type of system that requires the exhaust to be filtered before entering the atmosphere and for any type of filter system winch regenerates the filter by heating and/or combusting particulates trapped in the filter.

Advantageously, the present invention provides a method and apparatus for heating an exhaust filter structure to a temperature of 550° C. By uniformly heating the filter material to this temperature, the present invention is particularly useful for filtering diesel engine exhaust gases which require a temperature of 550° C. for combustion of particulates trapped in the filter.

As depicted in FIG. 1, the regenerative filter assembly 10 includes a housing assembly 12 and a microwave RF energy source assembly 14. The microwave energy source 14 inputs RF energy into the filter body which causes a lossy media within the filter body to rise to a temperature of 550° C. In fact, this is accomplished using a coaxial cavity feed which provides uniform heating. The center conductor serves as an antenna and launches microwave RF energy in a radial direction. In prior art devices, it was difficult to uniformly heat the exhaust gases to a temperature of 550° C. because typical flow volume is 35 cubic feet per minute at a lower temperature of 200° C. which cools the filter material and prevents combustion from occurring.

The filter body 10 includes a central section 16, an outlet section 18 and an inlet section 20. The filter body 10 is made from stainless steel to resist corrosion. The central section 16 is a filter section and has a cylindrical shape. The inlet and outlet sections 13 and 20 are symmetrical with the inlet section 20 having an inlet portion 22 having a first diameter and a conical second section 24 which extends from an edge of the inlet section 22 radially and is connected to the outside diameter of the filter section 16. Similarly, the outlet section 18 has an outlet portion 30 and a second conical section 28 connected to an outlet side of the filter section 16. Although the inlet and outlet sections 18 and 20 are illustrated as bolted to the central section 16, any other fastening method could be used including welding or folding, for example.

When used as a diesel engine exhaust filter, the exhaust flow through filter assembly 10 is approximately 35 cubic feet per minute. To reduce the flow rate through the filter section 16, the diameter of filter section 16 is larger than the inlet portion 22 and the outlet portion 30.

A differential pressure gauge 120 is used to measure a pressure drop across the central section 16 in which the filter materials are located. The differential pressure gauge 120 sends a signal indicative of the pressure drop across the filter to a controller (not shown). The controller then provides electrical power to the microwave energy source 14. It should be understood that any conventional method of measuring pressure drop across the filter can be used in the present invention. When the pressure drop reaches a predetermined level the controller can energize the microwave energy source 14 to heat the filter material to regenerate the filter.

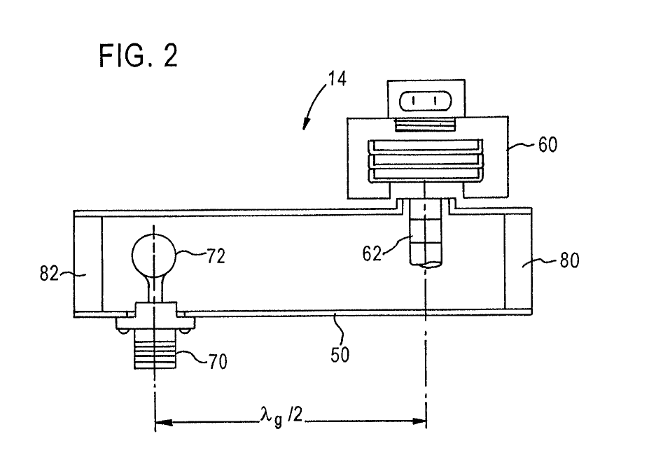

Referring now to FIG. 2, the microwave assembly 14 includes a rectangular waveguide 50. Mounted to one end of the rectangular waveguide 50 and is a magnetron 60 having an antenna 62 which extends into the rectangular waveguide 50. In the preferred embodiment, the magnetron 60 is a 1,000 watt 2450 megahertz magnetron commonly used in domestic microwave ovens. A probe 72 is located at the other end of the rectangular waveguide 50 at a spacing of λ_{g}/2. The magnetron 60 and the probe 62 are separated by 360 electrical degrees so that the same phase is emitted by the magnetron. The rectangular waveguide 50 has adjustable end walls 80, 82 which are adjusted to ensure that all the power from the magnetron 60 is carried by the waveguide 50 and is coupled into the probe. The end walls 80, 82 of the rectangular waveguide are movable in a direction towards and away from the antenna 62 and the probe 72, respectively, such so that all the RF microwave energy emitted by the magnetron 60 is coupled into the probe 72 and then into a coaxial cable 110 as discussed in detail below.

Referring back to FIGS. 1A and 1B, an n-type connector 70 connects the probe 72 to the coaxial cable 110 and extends through wall 24 of the filter body 10 and through the rectangular waveguide 50. An outer conduit 90 made of stainless steel extends between an inner surface of wall 24 and a reflective screen 100. The reflective screen 100 is positioned at an inlet edge in the filter section 16 and extends between inner surfaces thereof. Thus, all flow must pass through the reflective screen 100. The coaxial cable 110 is coupled to the n-type connector 70 and to the probe 72 and extends from the n-type connector 70 and the reflective screen 100. An end surface of the coax cable 110 abuts reflective screen 100. The reflective screen 100 divides the filter section 16 into an input section 130 and an output section 132. The reflective screen 100 is perforated to allow gas or liquid to pass through. An input screen 120 is positioned at the junction between the second conical input section 24 and an inlet edge of the filter section 16 and is sandwiched in between. Bolts fasten together the inlet edge of the filter section 16 and extend through the reflective screen 100 (see FIG. 1B). The reflective screen 100 material is stainless steel and holes are 0.250 inch in diameter on 0.312 inch centers. The input section 130 is further divided into a more central annular area 140 which extends radially outwardly from annular area an outside diameter of the conduit 90 and the reflective screen 100 and the input screen 120. A second outer volume 142 is concentric to and formed between the inner volume 140 and an inner wall of the filter section 16 and the reflective screen 100 and the input screen 120. All of the flow passing through the filter body must pass through either the second outer annular area 142 or the central annular area 140. A silicon carbide material with lower loss is placed in volume 140 and is surrounded by a silicon carbide material with a higher loss in volume 142. Typically the lossy material in volume 142 will be the same material as the material placed in volume 130. The conduit 90 terminates at the screen 120. The microwave power from the coaxial cable 110 is coupled to the TM₂₀₀ coaxial cavity mode which exists between the reflective screen 100 and the input screen 120. The low lossy material 142 allows most of the energy to pass through to the higher lossy material in volume 142. Because the coaxial cable 110 is centrally located, the RF energy is distributed uniformly and evenly. The predetermined distance between the input screen 120 and the reflective screen 100 is such to initiate almost complete coupling to the TM₂₀₀ mode pattern.

In operation, the filter material is heated from time to time when the pressure drop reaches the predetermined level to regenerate the filter. Alternatively, the filter material can be heated periodically or can be operated continuously.

It is readily seen by one of ordinary skill in the art that the present invention provides all of the advantages set forth above. After reading the foregoing specification, one of ordinary skill will be able to affect various changes, substitutions of equivalents and various other aspects of the invention as broadly disclosed herein. It is therefore intended that the protection granted hereon be limited by the definition contained in the appended claims and equivalents thereof.

What is claimed is:

1. A silicon carbide filter, comprising:
a filter body having a cavity formed therein;
a microwave RF energy source coupled to said filter body;
a centrally located energy radiator having an antenna output and coupled to said microwave energy source and capable of emitting microwave RF energy generated by said microwave energy source; and
a lossy media disposed in said cavity for absorbing emitted microwave energy;
wherein a central portion of said cavity is less lossy than an outer annular portion of said cavity.

2. The silicon carbide filter of claim 1, wherein said lossy media is one of a good conductor, a poor conductor and a lossy dielectric.

3. The silicon carbide filter of claim 1, wherein said microwave energy source is a magnetron.

4. The silicon carbide filter of claim 1, further comprising a waveguide connected to said filter body through a connector.

5. The silicon carbide filter of claim 1, wherein said energy radiator is a magnetron.

6. The silicon carbide filter of claim 1, wherein said energy radiator is a coaxial cable.

7. The silicon carbide filter of claim 1, wherein said magnetron has a 1,000 watt output.

8. The silicon carbide filter of claim 4, wherein said waveguide is a rectangular waveguide.

9. The silicon carbide filter of claim 4, wherein said connector is connected on one end to a probe and on an opposite end to said energy radiator.

10. The silicon carbide filter of claim 1, wherein said filter body defines an internal volume bounded by an input screen and an output screen.

11. The silicon carbide filter of claim 10, further comprising a reflective screen spaced a predetermined distance from said input screen to define a reflective input lossy volume and to define an output lossy volume between said reflective screen and said output screen.

12. The silicon carbide filter of claim 11, wherein in said input lossy volume said lossy media includes a central less lossy section and an outer more lossy section.

13. The silicon carbide filter of claim 1, wherein said lossy media is a silicon carbide.

14. The silicon carbide filter of claim 4, wherein said microwave RF energy source is spaced λ_{g}/2 from said connector.

15. The silicon carbide filter of claim 12, wherein in said outlet lossy volume said lossy media is less lossy than in said input lossy volume.

16. The silicon carbide filter of claim 1, wherein the microwave energy sourced is energized from time to time.

17. The silicon carbide filter of claim 1, wherein said energy radiator is centrally located in said filter body.

18. A silicon carbide filter, comprising:
a filter body having a cavity formed therein;
a microwave RF energy source coupled to said filter body;
an energy radiator coupled to said microwave energy source and capable of emitting microwave RF energy generated by said microwave energy source; and
a lossy media disposed in said cavity for absorbing emitted microwave energy;
a reflective screen spaced a predetermined distance from said input screen to define on reflective input lossy volume and to define an output lossy volume between said reflective screen and said output screen;
said input lossy volume includes a central less lossy section and an outer more lossy section;
wherein in said outlet lossy volume said lossy media is less lossy than in said input lossy volume.

19. The silicon carbide filter of claim 18, wherein said lossy media is one of a good conductor, a poor conductor and a lossy dielectric.

20. The silicon carbide filter of claim 18, wherein said microwave energy source is magnetron.

21. The silicon carbide filter of claim 18, wherein further comprising a waveguide connected to said filter body through a connector.

22. The silicon carbide filter of claim 18, wherein said energy radiator is a coaxial cable.

23. The silicon carbide filter of claim 18, wherein the microwave energy sourced is energized from time to time.

24. The silicon carbide filter of claim 18, wherein said energy radiator is centrally located in said filter body.

25. A method of regenerating a filter, comprising:
emitting microwave energy radially outwardly from a centrally located emitter located in a filter body to uniformly heat a lossy material located in the filter body.
